(19) United States
(12) Patent Application Publication
(10) Pub. No.: US 2014/0233525 A1
(43) Pub. Date: Aug. 21, 2014

(54) METHOD AND APPARATUS FOR ALLOCATING RESOURCES IN WIRELESS COMMUNICATION SYSTEM

(71) Applicants: Kitae Kim, Anyang-si (KR); Jinyoung Chun, Anyang-si (KR); Sunam Kim, Anyang-si (KR); Jiwon Kang, Anyang-si (KR); Binchul Ihm, Anyang-si (KR); Sungho Park, Anyang-si (KR)

(72) Inventors: Kitae Kim, Anyang-si (KR); Jinyoung Chun, Anyang-si (KR); Sunam Kim, Anyang-si (KR); Jiwon Kang, Anyang-si (KR); Binchul Ihm, Anyang-si (KR); Sungho Park, Anyang-si (KR)

(73) Assignee: LG ELECTRONICS INC., Seoul (KR)

(21) Appl. No.: 14/351,517

(22) PCT Filed: Sep. 11, 2012
(86) PCT No.: PCT/KR2012/007287

§ 371 Date: Apr. 11, 2014

Related U.S. Application Data
(60) Provisional application No. 61/546,561, filed on Oct. 13, 2011.

(51) Int. Cl. H04L 5/00

(52) U.S. Cl. CPC H04L 5/0037
USPC 370/329

(57) ABSTRACT

A method for a base station to transmit a Demodulation Reference Signal (DMRS) for a control channel in a wireless communication system is disclosed. The method includes transmitting a DMRS for an Enhanced-Physical Downlink Control Channel (E-PDCCH) to a user equipment, wherein a DMRS sequence corresponding to the transmitted DMRS is formed using an initial sequence calculated based on a virtual cell ID.

### TECHNICAL FIELD

The present invention relates to a wireless communication system and, more particularly, to a method and apparatus for allocating frequency resources of new control channels presenting in data regions of nodes in a distributed multi-node system.

### BACKGROUND ART

Recently, attention is being paid to a Multiple-Input Multiple-Output (MIMO) system to maximize the performance and communication capacity of a wireless communication system. MIMO technology refers to a scheme capable of improving data transmission/reception efficiency using multiple transmit antennas and multiple receive antennas, instead of using a single transmit antenna and a single receive antenna. The MIMO system is also called a multi-antenna system. MIMO technology applies a technique of completing a whole message by gathering data fragments received via several antennas without depending on a single antenna path in order to form one whole message. Consequently, MIMO technology can improve data transmission rate in a specific range or increase a system range at specific data transmission rate.

MIMO technology includes transmit diversity, spatial multiplexing, and beamforming. Transmit diversity is a technique for increasing transmission reliability by transmitting the same data through multiple transmit antennas. Spatial multiplexing is a technique capable of transmitting data at high rate without increasing system bandwidth by simultaneously transmitting different data through multiple transmit antennas. Beamforming is used to increase a Signal to Interference plus Noise Ratio (SINR) of a signal by adding a weight to multiple antennas according to a channel state. In this case, the weight can be expressed by a weight vector or a weight matrix, which is respectively referred to as a precoding vector or a precoding matrix.

Spatial multiplexing is divided into spatial multiplexing for a single user and spatial multiplexing for multiple users. Spatial multiplexing for a single user is called Single User MIMO (SU-MIMO) and spatial multiplexing for multiple users is called Spatial Division Multiple Access (SDMA) or Multi User MIMO (MU-MIMO).

The capacity of a MIMO channel increases in proportion to the number of antennas. The MIMO channel may be divided into independent channels. Assuming that the number of transmit antennas is Nt and the number of receive antennas is Nr, the number of independent channels, Ni, is Ni=min{Nt, Nr}. Each of the independent channels may be said to be a spatial layer. A rank is the number of non-zero eigenvalues of a MIMO channel matrix and may be defined as the number of spatial streams that can be multiplexed.

In the MIMO system, each transmit antenna has an independent data channel. The transmit antenna may mean a virtual antenna or a physical antenna. A receiver estimates a channel for each transmit antenna to receive data transmitted from each transmit antenna. Channel estimation refers to a process of restoring a received signal by compensating for distortion of the signal caused by fading. Fading refers to a phenomenon in which signal strength abruptly varies due to multi-path time delay in a wireless communication system environment. For channel estimation, a reference signal that is known to both a transmitter and a receiver is needed. The reference signal may be referred simply to as an RS or may be referred to as a pilot according to applied standard.

A downlink reference signal is a pilot signal for coherent demodulation of a Physical Downlink Shared Channel (PDSCH), a Physical Control Format Indicator Channel (PCFICH), a Physical Hybrid Indicator Channel (PHICH), a Physical Downlink Control Channel (PDCCH), etc. The downlink reference signal includes a Common Reference Signal (CRS) shared by all User Equipments (UEs) in a cell and a Dedicated Reference Signal (DRS) for a specific UE. The CRS may be called a cell-specific reference signal and the DRS may be called UE-specific reference signal.

As compared to a legacy communication system supporting a transmit antenna, (e.g. a system according to LTE releases 8 or 9), a system having an extended antenna configuration, (e.g. a system supporting 8 transmit antennas according to LTE-A), needs to transmit a reference signal for obtaining Channel State Information (CSI), i.e. a CSI-RS, in a receiver.

### DISCLOSURE

### Technical Problem

An object of the present invention is to provide a method and apparatus for efficiently allocating resources for a physical channel in a wireless communication system. Another object of the present invention is to provide a channel format and signal processing for efficiently transmitting control information, and an apparatus therefor. A further object of the present invention is to provide a method and apparatus for efficiently allocating resources for transmitting control information.

It will be appreciated by persons skilled in the art that that the technical objects that can be achieved through the present invention are not limited to what has been particularly described hereinabove and other technical objects of the present invention will be more clearly understood from the following detailed description.

### Technical Solution

The object of the present invention can be achieved by providing a method for a base station to transmit Demodulation Reference Signal (DMRS) for a control channel in a wireless communication system, including transmitting a DMRS for an Enhanced-Physical Downlink Control Channel (E-PDCCH) to a user equipment, wherein a DMRS sequence corresponding to the transmitted DMRS is formed using an initial sequence calculated based on a virtual cell ID.

In another aspect of the present invention, provided herein is a method for a user equipment to receive a Demodulation Reference Signal (DMRS) for a control channel in a wireless communication system, including receiving a DMRS for an Enhanced-Physical Downlink Control Channel (E-PDCCH) from a base station, wherein a DMRS sequence corresponding to the received DMRS is formed using an initial sequence calculated based on a virtual cell ID.

In a further aspect of the present invention, provided herein is a base station for transmitting a Demodulation Reference Signal (DMRS) for a control channel in a wireless communication system, including a Radio Frequency (RF) unit and a processor, wherein the processor controls the RF unit to transmit a DMRS for an Enhanced-Physical Downlink Control Channel (E-PDCCH) to a user equipment, and a DMRS sequence corresponding to the transmitted DMRS is formed using an initial sequence calculated based on a virtual cell ID.

In still another aspect of the present invention, provided herein is a user equipment for receiving a Demodulation Reference Signal (DMRS) for a control channel in a wireless communication system, including a Radio Frequency (RF) unit and a processor, wherein the processor controls the RF unit to receive a DMRS for an Enhanced-Physical Downlink Control Channel (E-PDCCH) from a base station, and a DMRS sequence corresponding to the received DMRS is formed using an initial sequence calculated based on a virtual cell ID.

If the E-PDCCH is transmitted in an interleaving region, the number of virtual cell IDs may be one and, if the E-PDCCH is transmitted in a non-interleaving region, the number of virtual cell IDs may be plural.

The virtual cell ID may be transmitted through Radio Resource Control (RRC) signaling.

If the E-PDCCH is transmitted in a non-interleaving region, the virtual cell ID may be identical to a cell ID for generating a Channel State Information Reference Signal (CSI-RS) sequence and, if the E-PDCCH is transmitted in an interleaving region, the virtual cell ID may be identical to one of a plurality of cell IDs for generating a plurality of CSI-RS sequences.

If the E-PDCCH is transmitted in a non-interleaving region, the virtual cell ID may be identical to one of sets of a plurality of predefined cell IDs according to a physical cell ID.

The initial cell ID calculated based on the virtual cell ID may conform to the following equation:

cᵢₙᵢₜ=(└nₛ/2┘+1)·(2N_{ID}^{cell}+1)·2¹⁶+n_{SCID}

where Cᵢₙₜ denotes an initial sequence, nₛ denotes a slot number in one radio frame, N_{ID}^{cell} denotes a virtual cell ID, and n_{SCID} denotes a user equipment-specific unique ID.

### Advantageous Effects

According to embodiments of the present invention, resources for a physical channel can be efficiently allocated in a wireless communication system, desirably, in a distributed multi-node system.

It will be appreciated by persons skilled in the art that that the effects that can be achieved through the present invention are not limited to what has been particularly described hereinabove and other advantages of the present invention will be more clearly understood from the following detailed description.

### DESCRIPTION OF DRAWINGS

The accompanying drawings, which are included to provide a further understanding of the invention, illustrate embodiments of the invention and together with the description serve to explain the principle of the invention.

In the drawings:

FIG. 1 illustrates the structure of a DAS to which the present invention is applied;

FIG. 2 illustrates a control region in which a PDCCH can be transmitted in a 3GPP LTE/LTE-A system;

FIG. 3 illustrates the structure of a UL subframe used in a 3GPP system;

FIG. 4 illustrates an E-PDCCH and a PDSCH scheduled by the E-PDCCH;

FIG. 5 illustrates the structure of an R-PDCCH transmitted to a relay node;

FIG. 6 illustrates allocation of an E-PDCCH according to prior art 1);

FIG. 7 illustrates allocation of an E-PDCCH according to prior art 2);

FIG. 8 illustrates cross-interleaving of an E-PDCCH;

FIG. 9 illustrates exemplary allocation of an E-PDCCH to a resource configuration region for cross interleaving or non-cross interleaving according to an exemplary embodiment of the present invention; and

FIG. 10 illustrates a BS and a UE which are applicable to an exemplary embodiment of the present invention.

### BEST MODE

Reference will now be made in detail to the exemplary embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the invention. The following detailed description includes specific details in order to provide a thorough understanding of the present invention. However, it will be apparent to those skilled in the art that the present invention may be practiced without such specific details. For example, although the following detailed description is given under the assumption of a 3GPP LTE system or an IEEE 802.16m system it is applicable to other mobile communication systems except for matters that are specific to the 3GPP LTE system or IEEE 802.16m system.

In some instances, known structures and devices are omitted or are shown in block diagram form, focusing on important features of the structures and devices, so as not to obscure the concept of the present invention. The same reference numbers will be used throughout this specification to refer to the same parts.

A wireless communication system to which the present invention is applicable includes at least one Base Station (BS). Each BS provides a communication service to a User Equipment (UE) located in a specific geographic area (generally, referred to as a cell). The UE may be fixed or mobile and includes various devices that transmit and receive user data and/or control information through communication with the BS. The UE may be referred to as a terminal equipment, a Mobile Station (MS), a Mobile Terminal (MT), a User Terminal (UT), a Subscriber Station (SS), a wireless device, a Personal Digital Assistant (PDA), a wireless modem, a handheld device, etc. The BS refers to a fixed station communicating generally with UEs and/or other BSs and exchanges data and control information with the UEs and other BSs. The BS may be referred to as an evolved-NodeB (eNB), a Base Transceiver System (BTS), an Access Point, a Processing Server (PS), etc.

A cell area in which a BS provides a service may be divided into a plurality of subareas in order to improve system performance. Each of the plurality of subareas may be referred to as a sector or a segment. A cell identity (Cell ID or IDCell) is assigned based on a total system, whereas a sector or segment identity is assigned based on a cell area in which the BS provides a service. Generally, a UE is distributed in a wireless communication system and may be fixed or mobile. Each UE may communicate with one or more BSs through Uplink (UL) or Downlink (DL) at a given time.

The present invention may be applied to various types of multi-node systems. For example, the embodiments of the present invention may be applied to a Distributed Antenna System (DAS), a macro node having low power Radio Remote Heads (RRHs), a multi-BS cooperative system, a pico-/femto-cell cooperative system, and a combination thereof. In a multi-node system, one or more BSs connected to a plurality of nodes may cooperate with each other to simultaneously transmit signals to a UE or to simultaneously receive signals from the UE.

A DAS uses, for communication, a plurality of distributed antennas connected to one BS or one BS controller for managing a plurality of antennas located at a prescribed interval in an arbitrary geographic area (called a cell) through a cable or a dedicated line. In the DAS, each antenna or each antenna group may be one node of a multi-node system of the present invention. Each antenna of the DAS may operate as a subset of antennas included in one BS or one BS controller. Namely, the DAS is a kind of the multi-node system and a distributed antenna or antenna group is a kind of a node in a multi-antenna system. The DAS is distinguished from a Centralized Antenna System (CAS) having a plurality of antennas centralized at the center of a cell, in that a plurality of antennas included in the DAS is distributed at a prescribed interval in a cell. The DAS is different from a femto-/pico-cell cooperative system in that one BS or one BS controller manages all distributed antennas or distributed antenna groups located in a cell at the center of the cell, rather than each antenna unit manages an antenna area. The DAS is also different from a relay system or an ad-hoc network that uses a BS connected wirelessly to a relay station in that distributed antennas are connected to each other through a cable or a dedicated line. Moreover, the DAS is distinguished from a repeater that simply amplifies a signal and transmits the amplified signal in that a distributed antenna or a distributed antenna group can transmit a signal different from a signal transmitted by other distributed antennas or other distributed antenna groups to a UE located around the corresponding antenna or antenna group according to a command of a BS or a BS controller.

Nodes of a multi-BS cooperative system or femto-/pico-cell cooperative system operate as independent BSs and cooperate with one another. Accordingly, each BS of the multi-BS cooperative system or femto-/pico-cell cooperative system may be a node in a multi-node system of the present invention. Multiple nodes of the multi-BS cooperative system or femto-/pico-cell cooperative system are connected to one another through a backbone network and perform cooperative transmission/reception by performing scheduling and/or handover together. In this way, a system in which a plurality of BSs participates in cooperative transmission is referred to as a Coordinated Multi-Point (CoMP) system.

There are differences between various types of multi-node systems such as a DAS, a macro node having low power PRHs, a multi-BS cooperative system, and a femto-/pico-cell cooperative system. However, since the multi-node system is different from a single-node system (e.g. a CAS, a conventional. MIMO system, a conventional relay system, and a conventional repeater system) and a plurality of nodes of the multi-node system participates in providing a communication service to UEs through cooperation, the embodiments of the present invention can be applied to all types of multi-node systems. For convenience of description, the present invention will describe a DAS by way of example. However, the following description is purely exemplary. Since an antenna or an antenna group of a DAS may correspond to a node of another multi-node system and a BS of the DAS corresponds to one or more cooperative BSs of another multi-node system, the present invention is applicable to other multi-node systems in a similar way.

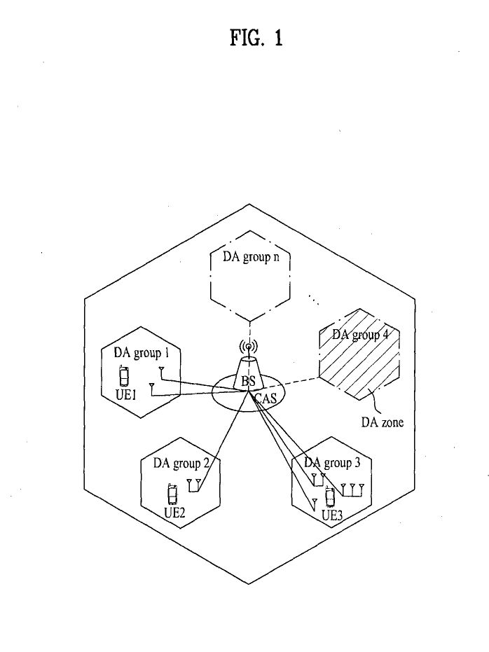

FIG. 1 illustrates the structure of a DAS to which the present invention is applied. Specifically, FIG. 1 illustrates the structure of a system in the case where the DAS is applied to a CAS using conventional cell-based multiple antennas.

Referring to FIG. 1, a plurality of Centralized Antennas (CAs) having similar path loss effects due to a very short antenna interval relative to a cell radius may be located in an area adjacent to a BS. In addition, a plurality of Distributed Antennas (DAs) separated from each other by a predetermined distance or more and having different path loss effects due to a wider antenna interval than the CAs may be located in a cell area.

One or more DAs connected by wire to the BS are configured. The DA has the same meaning as an antenna node for use in a DAS or as an antenna node. One or more DAs constitute one DA group to form a DA zone.

The DA group includes one or more DAs. The DA group may be variably configured according to the location or signal reception state of a UE or may be fixedly configured to a maximum antenna number used in MIMO. The DA group may be called an antenna group. The DA zone is defined as a range within which antennas forming a DA group can transmit or receive signals. The cell area shown in FIG. 1 includes n DA zones. A UE belonging to a DA zone may perform communication with one or more DAs constituting the DA zone. A BS simultaneously uses DAs and CAs while transmitting signals to a UE belonging to a DA zone, thereby raising transmission rate.

FIG. 1 illustrates a DAS applied to a CAS structure using conventional multiple antennas so that a BS and a UE can use the DAS. Although the locations of CAs and DAs are distinguished for brevity of description, the present invention is not limited thereto and the CAs and DAs are variously located according to implementation form.

As illustrated in FIG. 1, antennas or antenna nodes supporting each UE may be limited. Especially, during DL data transmission, different data for each antenna or antenna node may be transmitted to different UEs through the same time and frequency resources. This may be interpreted as a sort of MU-MIMO operation of transmitting different data streams per antenna or antenna node through selection of an antenna or antenna node.

In the present invention, each antenna or antenna node may be an antenna port. The antenna port is a logical antenna implemented by one physical transport antenna or a combination of a plurality of physical transport antennas. In the present invention, each antenna or antenna node may also be a virtual antenna. In a beamforming scheme, a signal transmitted by one precoded beam may be recognized as a signal transmitted by one antenna and the one antenna transmitting the precoded beam is called a virtual antenna. In the present invention, antennas or antenna nodes may be distinguished by a reference signal (pilot). An antenna group including one or more antennas that transmit the same reference signal or the same pilot refers to a set of one or more antennas that transmit the same reference signal or pilot. That is, each antenna or antenna node of the present invention may be interpreted as a physical antenna, a set of physical antennas, an antenna port, a virtual antenna, or an antenna distinguished by a reference signal/pilot. In the embodiments of the present invention to be described later, an antenna or antenna node may represent any one of a physical antenna, a set of physical antennas, an antenna port, a virtual antenna, and an antenna distinguished by a reference signal/pilot. Hereinafter, the present invention will be explained by referring to a physical antenna, a set of physical antennas, an antenna port, a virtual antenna, or an antenna distinguished by a reference signal/pilot as an antenna or antenna node.

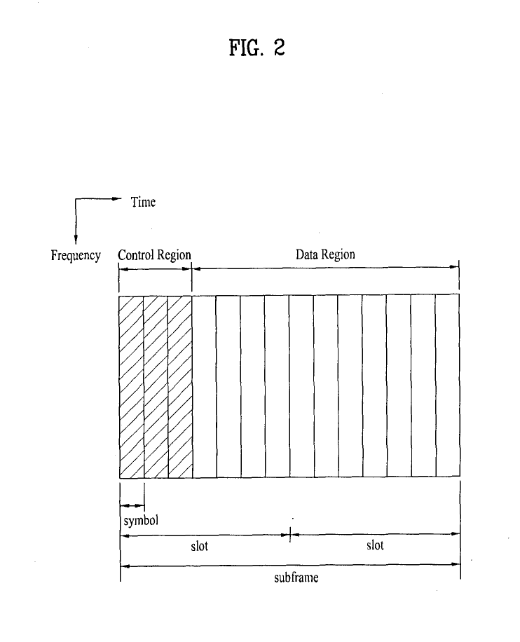

Referring to FIG. 2, a radio frame used in 3GPP LTE/LTE-A systems is 10 ms (327,200Tₛ) in duration and includes 10 equally-sized subframes, each subframe being 1 ms long. Each subframe includes two slots, each 0.5 ms in duration. Here, Tₛ represents a sampling time and is given as Tₛ=1/(2,048×15 kHz). A slot includes a plurality of Orthogonal Frequency Division Multiplexing Access (OFDMA) symbols in the time domain and a plurality of Resource Blocks (RBs) in the frequency domain. An RB includes a plurality of subcarriers in the frequency domain. An OFDMA symbol may be called an OFDM symbol or an SC-FDMA symbol according to a multiple access scheme. The number of OFDMA symbols included in one slot may vary according to channel bandwidth or the length of a Cyclic Prefix (CP). For example, in a normal CP, one slot includes 7 OFDMA symbols, whereas in an extended CP, one slot includes 6 OFDMA symbols. In FIG. 2, although a subframe in which one slot includes 7 OFDMA symbols is illustrated for convenience of description, the embodiments of the present invention to be described later are applicable to other types of subframes in a similar way. For reference, a resource composed of one OFDMA symbol and one subcarrier is called a Resource Element (RE) in the 3GPP LTE/LTE-A systems.

In the 3GPP LTE/LTE-A systems, each subframe includes a control region and a data region. The control region includes one or more OFDMA symbols starting from the first OFDMA symbol. The size of the control region may be independently configured for each subframe. A PCFICH, a Physical Hybrid automatic repeat request (ARQ) Indicator Channel (PHICH) as well as a PDCCH may be allocated to the control region.

As shown in FIG. 2, control information is transmitted to a UE using predetermined time and frequency resources among radio resources. Control information for UEs is transmitted together with MAP information in a control channel. Each UE searches for and then receives a control channel thereof among control channels transmitted by a BS. Resources occupied by control channels inevitably increase as the number of UEs within a cell increases. If Machine to Machine (M2M) communication and a DAS are actively used, the number of UEs in a cell will further increase. Then, control channels for supporting the UEs also increase. Namely, the number of OFDMA symbols and/or the number of subcarriers occupied by control channels in one subframe increase inevitably. Accordingly, the present invention provides methods for efficiently using a control channel using the characteristic of a DAS.

In accordance with current CAS-based communication standards, all antennas belonging to one BS transmit control channels (e.g. MAP, A-MAP, PDCCH etc.) for all UEs in the BS in a control region. To obtain control information such as information about an antenna node allocated to a UE and DL/UL resource allocation information, each UE should acquire control information thereof by processing the control region which is a common region scheduled for control information transmission. For instance, the UE should obtain control information thereof among signals transmitted through the control region by applying a scheme such as blind decoding.

According to current communication standards, if all antennas transmit control information for all UEs in the same control region, since all antennas transmit the same signal in the control region, implementation is easy. However, if the size of control information to be transmitted increases due to factors such as increase in the number of UEs that the BS should cover, MU-MIMO operation, and additional control information (e.g. information on an antenna node allocated to the UE) for a DAS, the size or number of control channels increases and thus it may be difficult to transmit all control information using an existing control region.

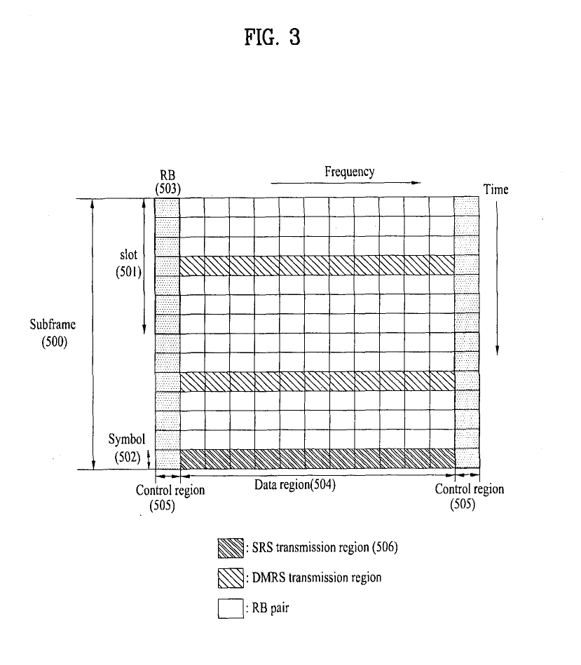

FIG. 3 illustrates a UL subframe structure in a 3GPP system.

Referring to FIG. 3, a 1-ms subframe 500, a basic unit for LTE UL transmission, includes two 0.5-ms slots 501. On the assumption of a normal CP, each slot has 7 symbols 502, each symbol corresponding to an SC-FDMA symbol. An RB 503 is a resource allocation unit defined as 12 subcarriers in the frequency domain and one slot in the time domain. The LTE UL subframe is largely divided into a data region 504 and a control region 505. The data region 504 refers to communication resources used to transmit data such as voice data and packets and includes a Physical Uplink Shared Channel (PUSCH). The control region 505 refers to communication resources used for each UE to transmit a DL channel quality report, an ACK/NACK for a received DL signal, and a UL scheduling request and includes a Physical Uplink Control Channel (PUCCH). A Sounding Reference Signal (SRS) is transmitted in the last SC-FDMA symbol of a subframe in the time domain and in a data transmission band in the frequency domain. SRSs transmitted in the last SC-FDMA symbol of the same subframe from a plurality of UEs can be distinguished by their frequency positions/sequences.

Hereinbelow, a description will be given of RB mapping. A Physical Resource Block (PRB) and a Virtual Resource Block (VRB) are defined. The PRB is configured as illustrated in FIG. 3. In other words, the PRB is defined as N_{symb}^{DL} contiguous OFDM symbols in the time domain and N_{sc}^{RB} contiguous subcarriers in the frequency domain. PRBs are numbered from 0 to N_{RB}^{DL}−1 in the frequency domain. The relationship between a PRB number n_{PRB} and an RE (h,l) in a slot is given by Equation 1.

$${n}_{PRB} = ⌊ \frac{k}{{N}_{sc}^{RB}} ⌋ \qquad [ Equation 1 ]$$

where k denotes a subcarrier index and N_{sc}^{RB} denotes the number of subcarriers in an RB.

The VRB is equal in size to the PRB. A Localized VRB (LVRB) of a localized type and a Distributed VRB (DVRB) of a distributed type are defined. Irrespective of VRB type, a pair of VRBs with the same VRB number n_{VRB} is allocated over two slots of a subframe.

SRSs are transmitted in the last SC-FDMA symbol of one subframe in the time domain and in a data transmission band in the frequency domain. SRSs transmitted in the last SC-FDMA symbol of the same subframe from a plurality of UEs can be distinguished by frequency position.

A Demodulation Reference Signal (DMRS) is transmitted in the middle SC-FDMA symbol of each slot in one subframe in the time domain and in a data transmission band in the frequency domain. For example, in a subframe to which a normal CP is applied, DMRSs are transmitted in the 4th and 11th SC-FDMA symbols.

The DMRS may be associated with the transmission of a PUSCH or PUCCH. The SRS is a reference signal transmitted from a UE to a BS for UL scheduling. The BS estimates a UL channel through the received SRS and uses the estimated UL channel for UL scheduling. The SRS is not associated with the transmission of a PUSCH or PUCCH. The same kind of basic sequence may be used for the DMRS and the SRS. Meanwhile, in UL multi-antenna transmission, precoding applied to the DMRS may be the same as precoding applied to the PUSCH.

The BS informs the UE of demodulation pilot information such as DMRS information of the BS so that the UE can directly measure a channel. The DMRS information includes a sequence, an RB type, an allocated resource type, a port position, the number of beams, or the number of ranks. Accordingly, the UE can obtain a PDSCH signal corresponding to a PDCCH through the PDCCH by use of the DMRS information.

A reference signal, especially, a DMRS sequence for a PUSCH may be defined by Equation 2.

$${r}_{{n}_{s}} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = 0 , 1 , … , 12 {N}_{RB}^{PDSCH} - 1 \qquad [ Equation 2 ]$$

Referring to Equation 2, a UE-specific reference signal rₙ_{ₛ}(m) for port 5 has a value between −1 and 1 by the difference between c(2m) or c(2m+1) and 1. A QPSK normalization value according to an average power value can be obtained by 1/\sqrt{2}. In Equation 2, c(i) denotes a pseudo-random sequence which is a PN sequence and may be defined by a length-31 Gold sequence. Equation 3 indicates an example of a Gold sequence c(n).

cᵢₙᵢₜ=(└nₛ/2┘+1)·(2N_{ID}^{cell}+1)·2¹⁶+n_{RNTI} [Equation 3]

where n_{RNTI} denotes a UE-specific unique ID.

Reference signals for other ports 7, 8, 9, and 10 may be defined by Equation 4.

$$r ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = \{ \begin{matrix}0 , 1 , … , 12 {N}_{RB}^{max , DL} - 1 & normal cyclic prefix \\ 0 , 1 , … , 16 {N}_{RB}^{max , DL} - 1 & extended cyclic prefix .\end{matrix} \qquad [ Equation 4 ]$$

In Equation 4, c(i) denotes a pseudo-random sequence, which is a PN sequence, and may be defined by a length-31 Gold sequence. Equation 5 indicates an example of the gold sequence c(n).

cᵢₙᵢₜ=(└nₛ/2┘+1)·(2N_{ID}^{cell}+1)·2¹⁶+n_{SCID} [Equation 5]

where Cᵢₙᵢₜ denotes an initial sequence, nₛ denotes a slot number in one radio frame, N_{ID}^{cell} denotes a virtual cell ID, n_{SCID} denotes a UE-specific unique ID for antenna ports 7 and 8 and may be defined by the following Table 1. Accordingly, n_{SCID} has a value of 0 or 1 and is transmitted as 1-bit signaling.

TABLE 1

| Scrambling identity field | |
|---|---|
| in DCI format 2B or 2C [3] | n_{SCID} |
| 0 | 0 |
| 1 | 1 |

As described above, n_{RNTI} or n_{SCID} is a value determined initially in a connection process between the UE and the BS.

A PDCCH indicates a control channel allocated to a DL subframe. In a system of 3GPP Rel-11 or more, introduction of a multi-node system including a plurality of access nodes in a cell has been determined for performance improvement (here, the multi-node system includes a DAS, an RRH, etc. and will be collectively referred to as an RRH hereinbelow). Standardization tasks for applying various MIMO schemes and cooperative communication schemes, that are being developed or are applicable in the future, to a multi-node environment is under way. Basically, although improvement of link quality is expected because various communication schemes such as a localized or cooperative scheme for each UE/BS can be applied due to the introduction of an RRH, the immediate introduction of a new control channel is needed in order to apply the above-mentioned various MIMO schemes and cooperative communication schemes to the multi-node environment. Due to such necessity, a control channel mentioned newly as a channel to be introduced is an Enhanced-PDCCH (E-PDCCH) (an RRH-PDCCH and an x-PDCCH are collectively referred to as an e-PDCCH) and a data transmission region (hereinafter, referred to as a PDSCH region) rather than a legacy control region (hereinafter, referred to as a PDCCH region) is preferred as an allocation position of the E-PDCCH. Consequently, it is possible for each UE to transmit control information for a node through the e-PDCCH and thus a problem caused by shortage of the legacy PDCCH region can be solved.

The legacy PDCCH is transmitted only using transmit diversity in a prescribed region and various schemes used for the PDSCH, such as beamforming, MU-MIMO, best band selection, etc., have not been applied to the legacy PDCCH. For this reason, the PDCCH functions as a bottleneck of system performance and improvement of this problem has been required. In the middle of discussing the new introduction of an RRH for system performance improvement, the necessity of a new PDCCH has been emerged as a method for overcoming insufficient capacity of the PDCCH when cell IDs of RRHs are the same. To distinguish a PDCCH to be newly introduced from the legacy PDCCH, the PDCCH to be newly introduced is referred to as an E-PDCCH. In the present invention, it is assumed that the E-PDCCH is located in the PDSCH region.

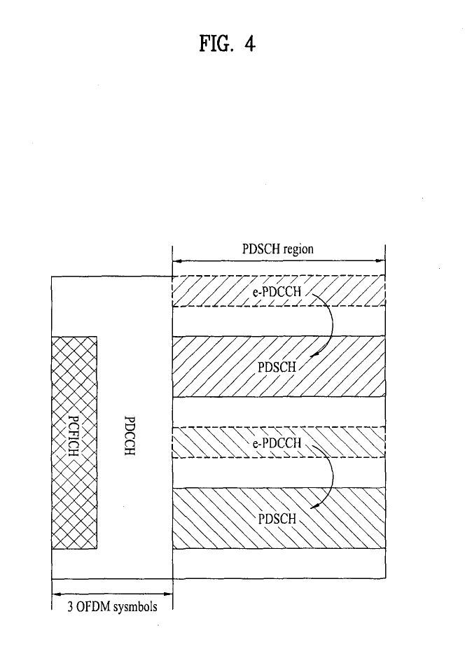

FIG. 4 is a diagram illustrating an E-PDCCH and a PDSCH scheduled by the E-PDCCH.

Referring to FIG. 4, the E-PDCCH may use part of a PDSCH region that generally transmits data. A UE should perform blind decoding to detect whether an E-PDCCH thereof is present. Although the E-PDCCH performs a scheduling operation (i.e. PDSCH and PUSCH control) like the legacy PDCCH, if the number of UEs connected to a node such as an RRH increases, a greater number of E-PDCCHs is allocated in the PDSCH region and thus the number of blind decoding attempts to be performed by the UE increases, thereby raising complexity.

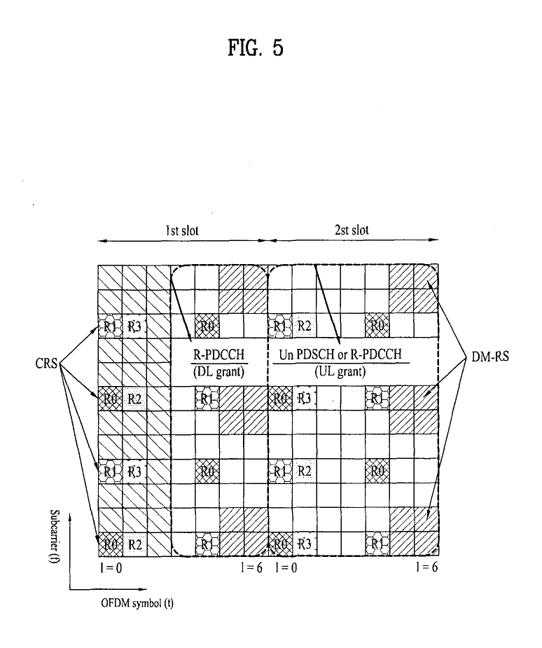

Meanwhile, an approach to reusing the structure of a legacy R-PDCCH is attempted as a detailed allocation scheme of the E-PDCCH. FIG. 5 is a diagram illustrating the structure of an R-PDCCH transmitted to a relay node.

Referring to FIG. 5, only a DL grant is necessarily allocated to the first slot and a UL grant or a data PDSCH may be allocated to the second slot. In this case, an R-PDCCH is allocated to data REs except for a PDCCH region, CRSs, and DMRSs. Both the DMRS and CRS may be used for R-PDCCH demodulation, and when the DMRS is used, port 7 and a Scrambling ID (SCID) of 0 are used.

Meanwhile, when the CRS is used, port 0 is used only when the number of PBCH transmit antennas is 1, and ports 0 and 1 and ports 0 to 3 are used in transmit diversity mode when the number of PBCH transmission antennas is 2 and 4, respectively.

In a detailed allocation scheme of the E-PDCCH, reusing the structure of the legacy R-PDCCH means separate allocation of a DL grant and a UL grant per slot. That is, the E-PDCCH has a structure following the R-PDCCH. This has an advantage that impact upon existing standard may be relatively insignificant by reusing a known structure.

In the present invention, such an allocation scheme is referred to as prior art 1).

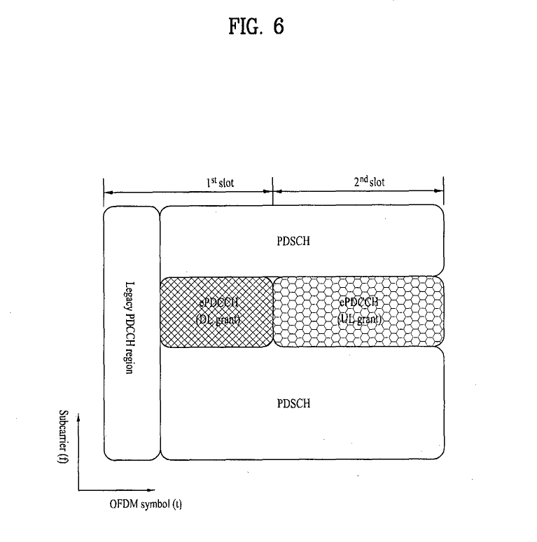

FIG. 6 is a diagram illustrating exemplary allocation of an E-PDCCH according to prior art 1).

According to prior art 1), the E-PDCCH is allocated in such a manner that a DL grant is allocated to the first slot of a subframe and a UL grant is allocated to the second slot of the subframe. Herein, it is assumed that the E-PDCCH is configured in both the first slot and the second slot of the subframe. The DL grant and UL grant are separately allocated to the E-PDCCH of the first slot and the E-PDCCH of the second slot, respectively.

Since the DL grant and the UL grant that a UE should detect per slot in a subframe are separated from each other, the UE configures a search region in the first slot to perform blind decoding for detecting the DL grant and configures a search region in the second slot to perform blind decoding for detecting the UL grant.

Meanwhile, a current 3GPP LTE system has a Downlink Transmission Mode (DL TM) and an Uplink Transmission Mode (UL TM). One TM per UE is configured through upper layer signaling. In the DL TM, the number of formats of DL control information that each UE should search for per configured mode, i.e. DCI formats, is 2. In the UL TM, on the other hand, the number of DCI formats that each UE should search for per configured mode is 1 or 2. For example, in UL TM 1, DL control information corresponding to a UL grant includes DCI format 0 and, in UL TM 2, DL control information corresponding to the UL grant includes DCI format 0 and DCI format 4. The DL TM is defined as one of mode 1 to mode 9 and the UL TM is defined as one of mode 1 and mode 2.

Accordingly, the number of blind decoding attempts that should be performed in DL grant and UL grant allocation regions in order for a UE to search for an E-PDCCH thereof in a UE-specific search region per slot as shown in FIG. 6 is as follows.

(1) DL grant=(number of candidate PDCCHs)×(number of DCI formats in configured DL TM)=16×2=32

(2) UL grant in UL TM 1=(number of candidate PDCCHs)×(number of DCI formats in UL TM 1)=16×1=16

(3) UL grant in UL TM 2=(number of candidate PDCCHs)×(number of DCI formats in UL TM 2)=16×2=32

(4) Total number of blind decoding attempts=number of blind decoding attempts in first slot+number of blind decoding attempts in second slot
UL TM 1: 32+16=48
UL TM 2: 32+32=64

Meanwhile, a method for simultaneously allocating both the DL grant and the UL grant to the first slot has been proposed. For convenience of description, this method is referred to as prior art 2).

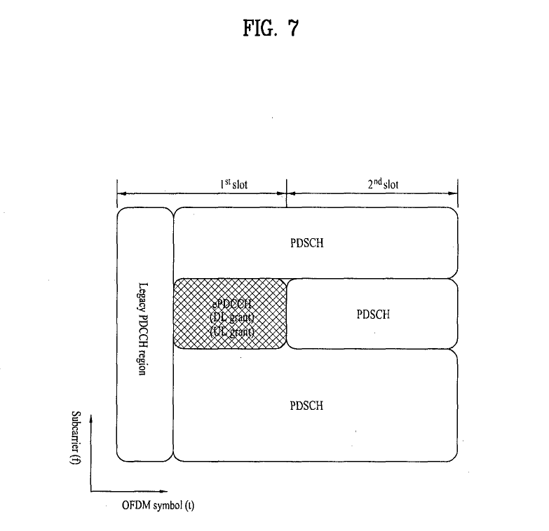

FIG. 7 is a diagram illustrating exemplary allocation of an E-PDCCH according to prior art 2).

Referring to FIG. 7, the E-PDCCH is allocated in such a manner that the DL grant and the UL grant are simultaneously allocated to the first slot of a subframe. Especially, it is assumed in FIG. 7 that the E-PDCCH is configured only in the first slot of a subframe. Therefore, both the DL grant and the UL grant are present in the E-PDCCH of the first slot and the UE performs blind decoding for searching for the DL grant and the UL grant only in the first slot of the subframe.

As mentioned previously, in the 3GPP LTE system, a DCI format to be detected is determined according to a TM configured per UE. Especially, a total of two DCI formats per DL TM, i.e. DL grants, is determined and all DL TMs basically include DCI format 1A to support a fallback mode. DCI format 0 among UL grants is equal to DCI format 1A in size and additional decoding is not performed because it can be distinguished through a 1-bit flag. However, for DCI format 4, which is the other format among the UL grants, additional blind decoding should be performed.

Accordingly, the UE performs blind decoding in the same region as the legacy PDCCH region and the number of blind decoding attempts that should be performed to search for the E-PDCCH in a UE-specific search region, i.e. the DL grant and the UL grant, is as follows.

(1) DL grant=(number of candidate PDCCHs)×(number of DCI formats in configured DL TM)=16×2=32

(2) UL grant in UL TM 1=(number of candidate PDCCHs)×(number of DCI formats in UL TM 1)=0

(3) UL grant in UL TM 2=(number of candidate PDCCHs)×(number of DCI formats in UL TM 2)=16×1=16

(4) Total number of blind decoding attempts
UL TM 1: 32+0=32
UL TM 2: 32+16=48

The present invention proposes a DL grant and UL grant allocation method of an E-PDCCH. As previously described, although a main design method of the E-PDCCH can follow the structure of the legacy R-PDCCH, there may be various methods for allocating a DL grant and a UL grant per slot in designing the E-PDCCH unlike the R-PDCCH.

Accordingly, the E-PDCCH, a DL control channel, has a pure FDM structure allocated only for the first slot. However, E-PDCCH allocation, which is being discussed, may be performed in a full FDM structure without being limited to one slot.

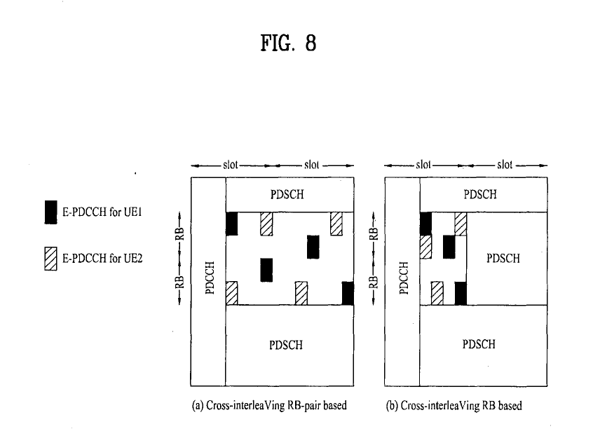

FIG. 8 illustrates exemplary cross-interleaving of the E-PDCCH.

Referring to FIG. 8, a method for multiplexing the E-PDCCH is used in a manner similar to an R-PDCCH multiplexing method. Under the state that a common PRB set is configured, E-PDCCHs of a plurality of UEs are interleaved in time and frequency domains. It can be confirmed in FIG. 8 that an E-PDCCH of each UE is divided into several E-PDCCHs. Through this method, frequency/time diversity over a plurality of RBs can be obtained and thus advantages can be expected from the standpoint of diversity gain.

In the present invention, a method of generating a DMRS sequence for decoding a newly defined E-PDCCH in a PDSCH region and a method for managing the sequence are proposed. In the present invention, a region to which the E-PDCCH is allocated is divided into an interleaving region (or a region with cross-interleaving) and a non-interleaving region (or a region without cross-interleaving) and a proper DMRS sequence generation method for a corresponding region is described. An effect of normalizing interference of a contiguous cell can be obtained using a proper DMRS sequence. That is, cell IDs for E-PDCCH regions can be separately transmitted to an interleaving region and a non-interleaving region.

Especially, in the interleaving region, a cell ID of each E-PDCCH for distinguishing between multiple UEs may be transmitted as a virtual cell ID. Namely, a cell ID for a DMRS sequence of an E-PDCCH may be transmitted using a different virtual cell ID per UE.

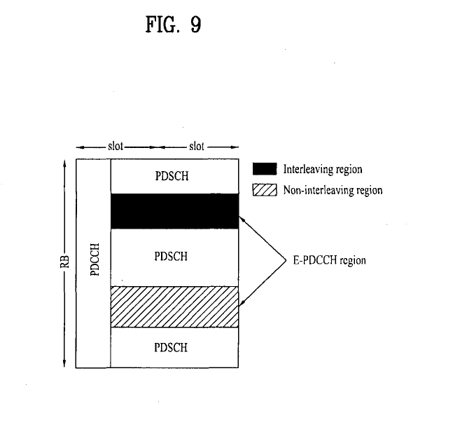

FIG. 9 illustrates exemplary allocation of an E-PDCCH to a resource configuration region for cross interleaving or non-cross interleaving according to an exemplary embodiment of the present invention.

Referring to FIG. 9, a resource region for an E-PDCCH format that is cross-interleaved, (hereinafter, referred to as an interleaving region), and a resource region for an E-PDCCH format that is not cross-interleaved, (hereinafter, referred to as a non-interleaving region), are configured. As another embodiment, a resource region for a common search space and a resource region for a UE-specific search space are configured. As a further embodiment, a resource region for a first RNTI set among multiple RNTIs and a resource region for a second RNTI are configured. Since the resource region for the common search space is commonly applied to UEs, it may be positioned in the cross interleaving region. However, since UE-specific interleaving is not performed in the non-interleaving region, a plurality of cell IDs may be used in the non-interleaving region. If the resource region of the E-PDCCH is comprised of the interleaving region and non-interleaving region, a DMRS configuration method per region is different according to characteristics of each region. Since multiple E-PDCCHs may be mixed in the interleaving region, the same antenna port and/or DMRS sequence should be configured. However, in the non-interleaving region, multiple antenna ports and/or DMRS sequences may be configured

In association with resource allocation of a PDSCH corresponding to a legacy PDCCH, since a cell ID is transmitted through RRC signaling, the cell ID is invariant. However, according to introduction of the E-PDCCH, the cell ID may be changed to a virtual cell ID in Equation 4 and Equation 5 in order to generate a DMRS sequence for E-PDCCH decoding. Namely, the same antenna port and DMRS sequence has been conventionally configured. However, since multiple RRHs may be present in one macro BS and thus multiple E-PDCCHs according to respective RRHs may be mixed, initial cell IDs may be changed to transmit multiple virtual cell IDs for DMRS reception.

Such characteristics of the present invention are applicable to both the interleaving region and the non-interleaving region. However, DMRS allocation for detecting the E-PDCCH for each UE is problematic in the interleaving region.

Equation 4 indicates a sequence transmitted to an actual DMRS RE. c(i) indicates a pseudo-random sequence and is generated in consideration of the number of DMRS REs in an allocated PRB. In determining an initial sequence Cᵢₙᵢₜ which is a seed value for generating the sequence c(i), a physical cell ID N_{ID}^{cell} and a UE-specific unique ID n_{SCID} are used as indicated in Equation 5 for generating a DMRS sequence for an antenna pε{7, 8, . . . , 14}. To detect an E-PDCCH in an interleaving region, a UE should be aware of a physical cell ID and a UE-specific unique ID n_{SCID} and an antenna port.

Accordingly, a cell ID of an interleaving region or a cell ID for a DMRS sequence of a non-interleaving region may be used instead of the UE-specific unique ID n_{SCID}. That is, according to initial ranging search, a cell ID for DMRS reception may be applied to the DMRS sequence instead of a cell ID obtained by a UE. Namely, the DMRS sequence corresponding to a transmitted DMRS signal may be formed using an initial sequence Cᵢₙᵢₜ calculated based on a virtual cell ID.

One physical cell ID N_{ID}^{cell} for generating the DMRS sequence of the interleaving region may be RRC signaled or may correspond to a cell ID for generating a Channel State Information (CSI) RS sequence. Namely, a virtual cell ID may be designated per port.

Multiple physical cell IDs N_{ID}^{cell} for generating the DMRS sequence of the non-interleaving region may be RRC signaled or may correspond to multiple physical cell IDs N_{ID}^{cell} generated using N_{ID}^{cell} for generating a CSI RS sequence.

To prevent N_{ID}^{cell} from overlapping with an existing cell ID, N_{ID}^{cell} may be controlled to have a value larger than the existing cell ID.

If a method proposed in the non-interleaving region is used, a quasi-orthogonal characteristic is maintained between terminals by assigning different DMRS sequences even to UEs receiving the same DMRS port and therefore spatial multiplexing capacity can be increased. A method for generating multiple IDs and a signaling method conform to the following proposal.

If a reference value of physical cell ID N_{ID}^{cell} for generating a DMRS sequence of the non-interleaving region is determined, a set of multiple predefined IDs is selected based on the reference value.

For example, if a physical cell ID is 1, a set of multiple N_{ID}^{cell} IDs {1, 2, 3, 4, 5 . . . 10} is selected, and if it is 2, {11, 12, 13, 14 . . . 20} is selected.

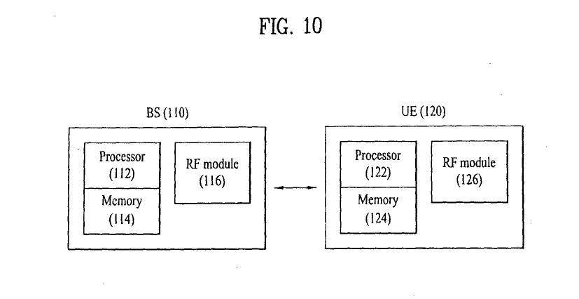

FIG. 10 illustrates a BS and a UE which are applicable to an exemplary embodiment of the present invention.

The UE may operate as a transmitter in UL and as a receiver in DL. Conversely, the BS may operate as a receiver in UL and as a transmitter in DL.

Referring to FIG. 10, a radio communication system includes a BS 110 and a UE 120. The BS 110 includes a processor 112, a memory 114, and a Radio Frequency (RF) unit 116. The processor 112 may be configured to implement the procedures and/or methods proposed in the present invention. The memory 114 is connected to the processor 112 and stores information related to operation of the processor 112. The RF unit 116 is connected to the processor 112 and transmits and/or receives RF signals. The UE 120 includes a processor 122, a memory 124, and an RF unit 126. The processor 122 may be configured to implement the procedures and/or methods proposed in the present invention. The memory 124 is connected to the processor 122 and stores information related to operation of the processor 122. The RF unit 126 is connected to the processor 122 and transmits and/or receives RF signals. The BS 110 and/or the UE 120 may have a single antenna or multiple antennas.

The above-described embodiments are combinations of constituent elements and features of the present invention in a predetermined form. The constituent elements or features should be considered selectively unless otherwise mentioned. Each constituent element or feature may be practiced without being combined with other constituent elements or features. Further, the embodiments of the present invention may be constructed by combining partial constituent elements and/or partial features. Operation orders described in the embodiments of the present invention may be rearranged. Some constructions or features of any one embodiment may be included in another embodiment or may be replaced with corresponding constructions or features of another embodiment. It is apparent that the embodiments may be constructed by a combination of claims which do not have an explicitly cited relationship in the appended claims or may include new claims by amendment after application.

The embodiments of the present invention may be achieved by various means, for example, hardware, firmware, software, or a combination thereof. In a hardware configuration, the exemplary embodiments of the present invention may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the exemplary embodiments of the present invention may be achieved by a module, a procedure, a function, etc. performing the above-described functions or operations. Software code may be stored in a memory unit and executed by a processor. The memory unit may be located at the interior or exterior of the processor and may transmit and receive data to and from the processor via various known means.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The present invention may be used for a UE, a BS, or other equipment of a wireless communication system. Specifically, the present invention may be used for a multi-node system that provides a communication service to a UE through a plurality of nodes.

1. A method for a base station to transmit a Demodulation Reference Signal (DMRS) for a control channel in a wireless communication system, the method comprising:
transmitting a DMRS for an Enhanced-Physical Downlink Control Channel (E-PDCCH) to a user equipment,
wherein a DMRS sequence corresponding to the transmitted DMRS is formed using an initial sequence calculated based on a virtual cell ID,
wherein the virtual cell ID is configured by Radio Resource Control (RRC) signaling.

2. The method according to claim 1, wherein, if the E-PDCCH is transmitted in an interleaving region, the number of virtual cell IDs is one and, if the E-PDCCH is transmitted in a non-interleaving region, the number of virtual cell IDs is plural.

3. (canceled)

4. The method according to claim 1, wherein, if the E-PDCCH is transmitted in a non-interleaving region, the virtual cell ID is identical to a cell ID for generating a Channel State Information Reference Signal (CSI-RS) sequence and, if the E-PDCCH is transmitted in an interleaving region, the virtual cell ID is identical to one of a plurality of cell IDs for generating a plurality of CSI-RS sequences.

5. The method according to claim 1, wherein, if the E-PDCCH is transmitted in a non-interleaving region, the virtual cell ID is identical to one of sets of a plurality of predefined cell IDs according to a physical cell ID.

6. The method according to claim 1, wherein the initial cell ID calculated based on the virtual cell ID conforms to the following equation:
cᵢₙᵢₜ=(└nₛ/2+1)·(2N_{ID}^{cell}+1)·2¹⁶+n_{SCID}
wherein Cᵢₙₜ denotes an initial sequence, nₛ denotes a slot number in one cell radio frame, N_{ID}^{cell} denotes a virtual cell ID, and n_{SCID} denotes a user equipment-specific unique ID.

7. A method for a user equipment to receive a Demodulation Reference Signal (DMRS) for a control channel in a wireless communication system, the method comprising:
receiving a DMRS for an Enhanced-Physical Downlink Control Channel (E-PDCCH) from a base station,
wherein a DMRS sequence corresponding to the received DMRS is formed using an initial sequence calculated based on a virtual cell ID,
wherein the virtual cell ID is configured by Radio Resource Control (RRC) signaling.

8. The method according to claim 7, wherein, if the E-PDCCH is received in an interleaving region, the number of virtual cell IDs is one and, if the E-PDCCH is received in a non-interleaving region, the number of virtual cell IDs is plural.

9. (canceled)

10. The method according to claim 7, wherein, if the E-PDCCH is transmitted in a non-interleaving region, the virtual cell ID is identical to a cell ID for generating a Channel State Information Reference Signal (CSI-RS) sequence and, if the E-PDCCH is transmitted in an interleaving region, the virtual cell ID is identical to one of a plurality of cell IDs for generating a plurality of CSI-RS sequences.

11. The method according to claim 7, wherein, if the E-PDCCH is transmitted in a non-interleaving region, the virtual cell ID is identical to one of sets of a plurality of predefined cell IDs according to a physical cell ID.

12. The method according to claim 7, wherein the initial cell ID calculated based on the virtual cell ID conforms to the following equation:
cᵢₙᵢₜ=(└nₛ/2┘+1)·(2N_{ID}^{cell}+1)·2¹⁶+n_{SCID}
wherein Cᵢₙₜ denotes an initial sequence, nₛ denotes a slot number in one radio frame, N_{ID}^{cell} denotes a virtual cell ID, and n_{SCID} denotes a user equipment-specific unique ID.

13. A base station for transmitting a Demodulation Reference Signal (DMRS) for a control channel in a wireless communication system, the base station comprising:
a Radio Frequency (RF) unit; and
a processor,
wherein the processor controls the RF unit to transmit a DMRS for an Enhanced-Physical Downlink Control Channel (E-PDCCH) to a user equipment, and a DMRS sequence corresponding to the transmitted DMRS is formed using an initial sequence calculated based on a virtual cell ID,
wherein the virtual cell ID is configured by Radio Resource Control (RRC) signaling.

14. The base station according to claim 13, wherein, if the E-PDCCH is transmitted in an interleaving region, the number of virtual cell IDs is one and, if the E-PDCCH is transmitted in a non-interleaving region, the number of virtual cell IDs is plural.

15. The base station according to claim 13, wherein, if the E-PDCCH is transmitted in a non-interleaving region, the virtual cell ID is identical to a cell ID for generating a Channel State Information Reference Signal (CSI-RS) sequence and, if the E-PDCCH is transmitted in an interleaving region, the virtual cell ID is identical to one of a plurality of cell IDs for generating a plurality of CSI-RS sequences.

16. The base station according to claim 13, wherein the initial cell ID calculated based on the virtual cell ID conforms to the following equation:
cᵢₙᵢₜ=(└nₛ/2┘+1)·(2N_{ID}^{cell}+1)·2¹⁶+n_{SCID}
wherein Cᵢₙₜ denotes an initial sequence, nₛ denotes a slot number in one radio frame, N_{ID}^{cell} denotes a virtual cell ID, and n_{SCID} denotes a user equipment-specific unique ID.

17-20. (canceled)
